(19) United States
(12) Patent Application Publication
(10) Pub. No.: US 2022/0270484 A1
(43) Pub. Date: Aug. 25, 2022

(54) PARKING LOT CONTROL SERVER, PARKING LOT CONTROL METHOD AND VEHICLE CONTROL APPARATUS

(71) Applicant: TOYOTA JIDOSHA KABUSHIKI KAISHA, Toyota-shi Aichi-ken (JP)

(72) Inventors: Tatsuo Sugano, Susono-shi Shizuoka-ken (JP); Noriyuki Tsuruoka, Susono-shi Shizuoka-ken (JP); Nobutsugu Maruiwa, Mishima-shi Shizuoka-ken (JP)

(21) Appl. No.: 17/673,223

(22) Filed: Feb. 16, 2022

(30) Foreign Application Priority Data
Feb. 19, 2021 (JP) 2021-025092

(51) Int. Cl. G08G 1/14; G08G 1/017

(52) U.S. Cl. CPC G08G 1/148; G08G 1/142; G08G 1/0175

(57) ABSTRACT

A parking lot control server includes: a storage configured to store contour information about a contour of each parked vehicle in a parking lot; an extractor configured to extract contour information corresponding to one or more parked vehicles that are around a travel path of a first vehicle that newly enters the parking lot; and a distributor configured to distribute the extracted contour information to the first vehicle.

### CROSS-REFERENCE TO RELATED APPLICATIONS

This application is based upon and claims the benefit of priority of the prior Japanese Patent Application No. 2021-025092, filed on Feb. 19, 2021, the entire contents of which are incorporated herein by reference.

### BACKGROUND

### 1. Technical Field

Embodiments of the present disclosure relate to a parking lot control server, a parking lot control method and a vehicle control apparatus.

### 2. Description of the Related Art

A proposed apparatus of this type is, for example, a parking area control apparatus for allowing an automatic traveling vehicle to enter a parking space in which a plurality of vehicles can be parked in parallel (see JP 2017-182230A as Patent Literature 1). Another proposed related technology/technique is a technology/technique of performing automatic parking assistance by remote operation from outside the vehicle (see JP2011-235816A as Patent Literature 2).

An autonomous function may allow a vehicle to travel unattended and to be parked. In this case, for example, since it is not necessary to provide an opening/closing space of a door for getting on and off, it is possible to relatively narrow a distance from an adjacent vehicle at the time of parking. On the other hand, when a new vehicle is parked in a condition where a plurality of vehicles are already parked, an on-vehicle sensor of the new vehicle may not be able to appropriately detect an obstacle that exists on the way to a target position due to the already parked vehicles, which is technically problematic.

### SUMMARY

In view of the problem described above, it is therefore an object of embodiments of the present disclosure to provide a parking lot control server, a parking lot control method and a vehicle control apparatus that are configured to appropriately park an autonomous vehicle.

The above object of embodiments of the present disclosure can be achieved by a parking lot control server including: a storage configured to store contour information about a contour of each parked vehicle in a parking lot; an extractor configured to extract contour information corresponding to one or more parked vehicles that are around a travel path of a first vehicle that newly enters the parking lot; and a distributor configured to distribute the extracted contour information to the first vehicle.

The above object of embodiments of the present disclosure can be achieved by a parking lot control method including: a first storage step of storing contour information about a contour of each parked vehicle in a parking lot; an extraction step of extracting contour information corresponding to one or more parked vehicles that are around a travel path of a first vehicle that newly enters the parking lot; and a distribution step of distributing the extracted contour information to the first vehicle.

The above object of embodiments of the present disclosure can be achieved by a vehicle control apparatus including: a receiver configured to receive contour information about a contour of a parked vehicle in a parking lot from a parking lot control server; a planner configured to make a traveling plan of a host vehicle on the basis of the contour information; and a controller configured to control the host vehicle such that the host vehicle travels automatically in accordance with the traveling plan.

### BRIEF DESCRIPTION OF THE DRAWINGS

FIG. 1 is a block diagram showing a configuration of a parking system according to an embodiment;

FIG. 2 is a flowchart showing an example of the operation of a parking lot control server according to the embodiment;

FIG. 3 is a flowchart showing another example of the operation of the parking lot control server according to the embodiment;

FIG. 4 is a flowchart showing another example of the operation of the parking lot control server according to the embodiment; and

FIG. 5 is a diagram showing a scene of parking.

### DETAILED DESCRIPTION OF THE EMBODIMENT

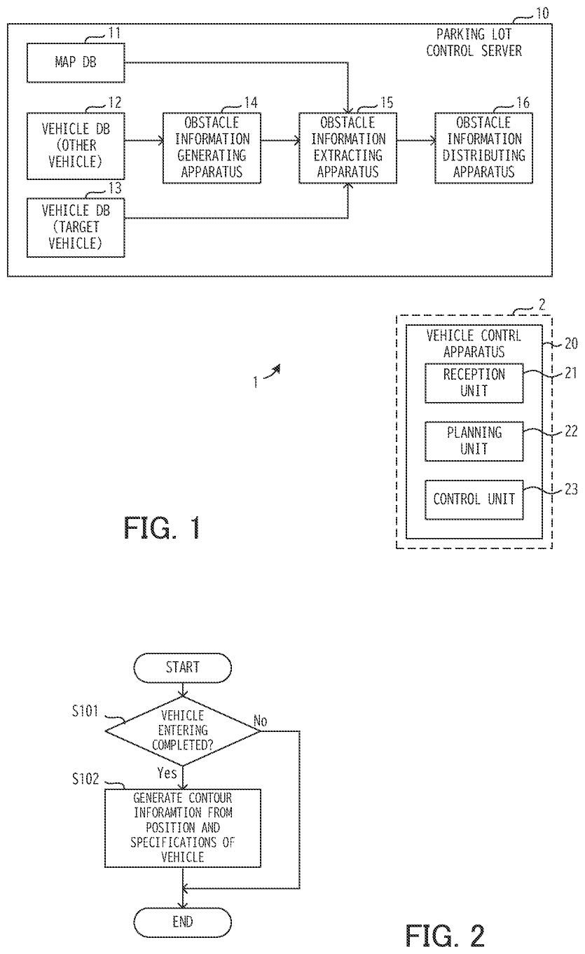

With reference to FIG. 1 to FIG. 5, a parking lot control server and the like according to an embodiment will be described. The embodiment described below presupposes automated valley parking (AVP). Firstly, the automated valley parking will be described, and then, the parking lot control server and the like according to the embodiment will be described.

An aspect of automated valley parking proposed is, for example, automated valley parking of an infrastructure coordination type, which assists a vehicle that travels automatically in a parking lot by using information obtained from a camera installed in the parking lot. In such automated valley parking, when a new vehicle enters, for example, a map of the parking lot, information on availability of a parking space, obstacle information, information indicating a target position, information indicating a travel path, and the like are distributed to the vehicle. The vehicle makes a traveling plan (e.g., sets a target track, a target velocity, etc.) on the basis of the distributed information and the output of an on-vehicle sensor or the like. Then, the vehicle travels automatically in accordance with the traveling plan.

The distributed obstacle information includes information indicating an object that is fixed to the parking lot, such as, for example, a column and a fence. On the other hand, the distributed obstacle information often does not include information indicating an object that is temporarily present in the parking lot, such as, for example, a pedestrian and a falling object. Such an object that is temporarily present in the parking lot is often detected by the on-vehicle sensor.

Incidentally, the automated valley parking often allows vehicles to travel unattended automatically. Therefore, from the viewpoint of improving parking space efficiency, attention is attracted to crowded parking that allows vehicles to be parked such that a distance is relatively narrow between the vehicles adjacent in a longitudinal direction and such that a distance is relatively narrow between the vehicles adjacent in a lateral direction.

In the crowded parking described above, an area in which a vehicle to be newly parked can travel may be defined by a plurality of parked vehicles. Since the parked vehicle is an object that is temporarily present in the parking lot, if no measures are taken, the vehicle to be newly parked need to detect the parked vehicle with its on-vehicle sensor and to specify the area in which the vehicle can travel. The on-vehicle sensor, however, may not be able to detect an obstacle that is behind a parked vehicle (e.g., another parked vehicle).

Therefore, a parking lot control server 10 according to the present embodiment stores contour information about a contour of each parked vehicle in the parking lot. The parking lot control server 10 extracts contour information corresponding to one or more parked vehicles that are around a travel path of a vehicle (e.g., a vehicle 2 in FIG. 1) that newly enters the parking lot, and extracts it to the newly entering vehicle.

Here, an explanation will be given to the parking lot control server 10 with reference to FIG. 1. In FIG. 1, the parking lot control server 10 and the vehicle 2 constitute a parking system 1. The parking lot control server 10 includes a map database 11, a vehicle database 12, a vehicle database 13, an obstacle information generating apparatus 14, an obstacle information extracting apparatus 15 and an obstacle information distributing apparatus 16.

The map database 11 stores therein map information on the parking lot. The map information includes information (e.g., position information, size information, etc.) about an obstacle, such as, for example, a wall, a fence, and a column (hereinafter referred to as a “static obstacle”). The map database 11 may store therein, for example, information on availability of each parking space and traffic restriction information, in addition to the map information.

The vehicle database 12 stores therein information about the vehicle that is not currently targeted by the vehicle parking lot control server 10 (hereinafter referred to as “other vehicle information”). The vehicle database 13 stores therein information about the vehicle that is currently targeted by the vehicle parking lot control server 10 (hereinafter referred to as “target vehicle information”).

The “vehicle that is currently targeted by the parking lot control server 10” is a vehicle that is traveling or that is about to start to travel. In other words, “the vehicle that is currently targeted by the parking lot control server 10” is a vehicle that is traveling or that is about to start to travel in accordance with the information that indicates a travel path and that is distributed from the parking lot control server 10. On the other hand, “the vehicle that is not currently targeted by the parking lot control server 10” is a vehicle that has already completed parking, and, a vehicle that is waiting for entering or leaving the parking lot.

The other vehicle information stored in the vehicle database 12 may include, for example, information indicating a status of a vehicle, position information, information indicating the specifications of the vehicle, and the like. The target vehicle information stored in the vehicle database 13 may include, for example, vehicle status information, position information, travel path information, and the like. The “vehicle status information” may include not only information indicating whether or not the vehicle is parked, but also information indicating a control state of the vehicle, such as, for example, starting to enter, entering, starting to leave, and leaving. The “travel path information” may include information indicating a travel start position, information indicating a target position, and information indicating a flow line from the travel start position to the target position.

The obstacle information generating apparatus 14 obtains the position information on the parked vehicle (in other words, the vehicle that has completed entering) and the information indicating the specifications of the vehicle, from the other vehicle information stored in the vehicle database 12. Then, the obstacle information generating apparatus 14 generates the contour information indicating the contour of the parked vehicle, which is an aspect of the obstacle information, on the basis of the obtained position information and the obtained information indicating the vehicle specifications. The generated contour information may be stored in the obstacle information generating apparatus 14, or may be stored in a storage apparatus that is different from the obstacle information generating apparatus 14.

The obstacle information extracting apparatus 15 obtains the travel path information included in the target vehicle information corresponding to one target vehicle, from the target vehicle information stored in the vehicle database 13. Then, the obstacle information extracting apparatus 15 extracts the contour information about the contour of a vehicle that is adjacent to the travel path (e.g., the flow line from the travel start position to the target position) indicated by the obtained travel path information, from among the contour information generated by the obstacle information generating apparatus 14. The obstacle information extracting apparatus 15 further obtains the travel path indicated by the obtained travel path information, and the map information on surroundings of the travel path, from the map database 11.

The obstacle information distributing apparatus 16 distributes the contour information and the map information (especially, the information about the static obstacle included in the map information) extracted by the obstacle information extracting apparatus 15 to the vehicle 2 that is the above-described one target vehicle. The parking lot control server 10 also distributes, to the vehicle 2 that is the above-described one target vehicle, the travel path information or the like included in the target vehicle information corresponding to the vehicle 2.

The vehicle control apparatus 20 mounted on the vehicle 2 includes a reception unit 21, a planning unit 22 and a control unit 23. The planning unit 22 makes a traveling plan of the vehicle 2 on the basis of the contour information and the map information or the like received via the reception unit 21 and on the basis of the output of a not-illustrated on-vehicle sensor. The control unit 23 controls the vehicle 2 (e.g., controls various actuators) such that the vehicle 2 travels automatically in accordance with the traveling plan.

Next, the operation of the parking lot control server 10 will be described with reference to the flowchart of FIG. 2 to FIG. 4. In FIG. 2, the parking lot control server 10 determines whether or not the target vehicle has completed entering the parking lot (step S101). In the step S101, when it is determined that the target vehicle has not completed entering the parking lot (the step S101: No), the operation illustrated in FIG. 2 is ended. Then, after a lapse of a first predetermined time (e.g., several tens of milliseconds to several hundred milliseconds), the step S101 may be performed again. That is, the operation illustrated in FIG. 2 may be repeated at a cycle corresponding to the first predetermined time.

In the step S101, when it is determined that the target vehicle has completed entering the parking lot (the step S101: Yes), the parking lot control server 10 transfers the target vehicle information corresponding to the target vehicle stored in the vehicle database 13, to the vehicle database 12 (as a result of which, the target vehicle information will be referred to as the other vehicle information). Then, the obstacle information generating apparatus 14 of the parking lot control server 10 generates the contour information from the position information and the information indicating the specifications of the vehicle that are included in the other vehicle information (i.e., the target vehicle information transferred to the vehicle database 12) (step S102). Then, after a lapse of the first predetermined time, the step S101 may be performed again.

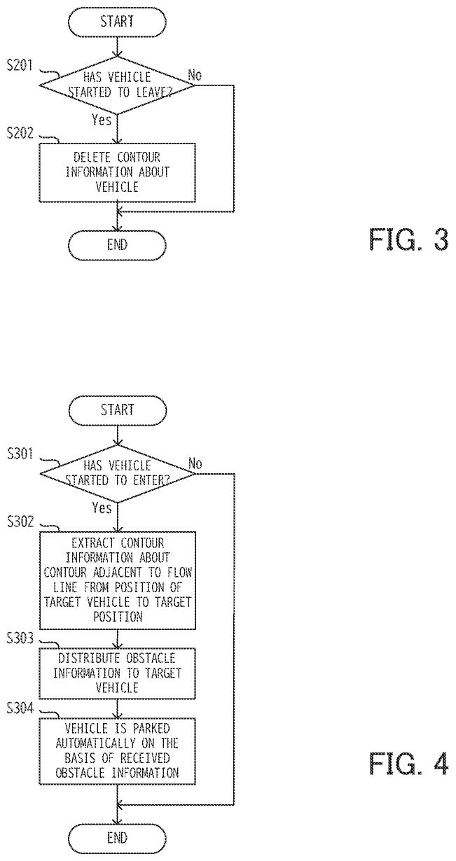

In FIG. 3, the parking lot control server 10 determines whether or not the target vehicle has started to leave the parking lot (step S201). In the step S201, when it is determined that the target vehicle has not started to leave the parking lot (the step S201: No), the operation illustrated in FIG. 3 is ended. Then, after a lapse of a second predetermined time (e.g., several tens of milliseconds to several hundred milliseconds), the step S201 may be performed again. That is, the operation illustrated in FIG. 3 may be repeated at a cycle corresponding to the second predetermined time.

In the step S201, when it is determined that the target vehicle has started to leave the parking lot (the step S201: Yes), the obstacle information generating apparatus 14 of the parking lot control server 10 deletes the contour information generated when the target vehicle enters the parking lot (i.e., generated by the operation illustrated in FIG. 2 described above) (step S202). Then, after a lapse of the second predetermined time, the step S101 may be performed again.

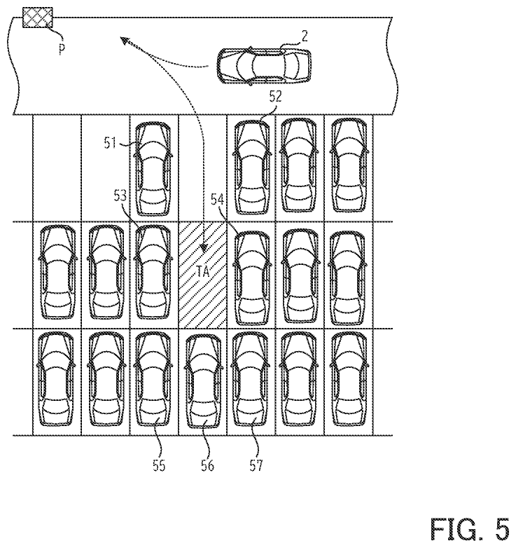

In FIG. 4, the parking lot control server 10 determines whether or not the target vehicle has started to enter the parking lot (step S301). In the step S301, when it is determined that the target vehicle has not started to enter the parking lot (the step S301: No), the operation illustrated in FIG. 4 is ended. Then, after a lapse of a third predetermined time (e.g., several tens of milliseconds to several hundred milliseconds), the step S301 may be performed again. That is, the operation illustrated in FIG. 4 may be repeated at a cycle corresponding to the third predetermined time.

In the step S301, when it is determined that the target vehicle has started to enter the parking lot (step S301: Yes), the obstacle information extracting apparatus 15 of the parking lot control server 10 extracts the contour information about the contour of a vehicle that is adjacent to the travel path (e.g., the flow line from the travel start position to the target position), from among the contour information generated by the obstacle information generating apparatus 14 (step S302).

Next, the obstacle information distributing apparatus 16 distributes the obstacle information including the contour information extracted by the obstacle information extraction apparatus 15 to the target vehicle (step S303). The vehicle control apparatus 20 of the vehicle 2 that is an example of the target vehicle controls the vehicle 2 to travel automatically in accordance with the traveling plan erected based on the received obstacle information or the like and to park the vehicle 2 (step S304). Then, after a lapse of the third predetermined time, the step S301 may be performed again.

Next, the obstacle information distributed from the target vehicle parking lot control server 10 to the vehicle 2 that is an example of the target vehicle will be specifically described with reference to FIG. 5. In FIG. 5, it is assumed that a parking space TA (see a diagonal-line part in FIG. 5) is the target position (in other words, a target parking position) of the vehicle 2. In FIG. 5, a dotted line arrow represents the flow line (in other words, a target track) to the target position of the vehicle 2.

In a scene illustrated in FIG. 5, the obstacle information extracting apparatus 15 extracts the contour information about each of parked vehicles 51, 52, 53, 54, 55, 56 and 57 that are adjacent to the flow line of the vehicle 2. At this time, the obstacle information extracting apparatus 15 may extract, for example, the coordinates of the left front corner, the coordinates of the right front corner, the coordinates of the left rear corner and the coordinates of the right rear corner of the parked vehicle 51 (i.e., the coordinates of the four corners of the parked vehicle 51), as the contour information about the parked vehicle 51.

In this instance, the obstacle information distributing apparatus 16 distributes the coordinates of the four corners of each of the parked vehicles 51, 52, 53, 54, 55, 56 and 57, to the vehicle 2. That is, in this case, the coordinates of the four corners of each parked vehicle are distributed to the vehicle 2 as the obstacle information.

The vehicle control apparatus 20 mounted on the vehicle 2, for example, is allowed to specify a rectangular area corresponding to an existence range of the parked vehicle 51 from the coordinates of the four corners of the parked vehicle 51. Similar processing allows the vehicle control apparatus 20 to specify a rectangular area corresponding to an existence range of each of the parked vehicles 52, 53, 54, 55, 56 and 57.

Alternatively, in the scene illustrated in FIG. 5, the obstacle information extracting apparatus 15 extracts the contour information of each of the parked vehicles 51, 52, 53, 54, 55, 56 and 57 that are adjacent to the flow line of the vehicle 2. At this time, the obstacle information extracting apparatus 15 may specify an area in which the vehicle 2 can travel, from the extracted contour information about each of the parked vehicle 51, 52, 53, 54, 55, 56 and 57. That is, the obstacle information extracting apparatus 15 may specify the area in which the vehicle 2 can travel, which is defined by the parked vehicles 51, 52, 53, 54, 55, 56 and 57, from the contour information. In this case, the obstacle information distributing apparatus 16 distributes information indicating the area in which the vehicle 2 can travel, which is specified by the obstacle information extracting apparatus 15, as the obstacle information, to the vehicle 2.

Alternatively, in the scene illustrated in FIG. 5, the obstacle information extracting apparatus 15 extracts the contour information about each of the parked vehicles 51, 52, 53, 54, 55, 56 and 57 that are adjacent to the flow line of the vehicle 2. The obstacle information distributing apparatus 16 may distribute, to the vehicle 2, the extracted contour information itself as the obstacle information.

In the scene illustrated in FIG. 5, the obstacle information extracting apparatus 15 obtains the information about the static obstacle (here, a column P) that is around the flow line of the vehicle 2, from the map database 11. The obstacle information distributing apparatus 16 also distributes the information relating to the static obstacle acquired by the obstacle information extracting apparatus 15 as the obstacle information, to the vehicle 2.

### Technical Effects

The parking lot control server 10 according to the embodiment stores the contour information about the contour of the parked vehicle. The parking lot control server 10 extracts the contour information corresponding to one or more parked vehicles that are around the travel path of a vehicle that newly enters the parking lot (e.g., the vehicle 2 in FIG. 1), and distributes it to the newly entering vehicle. Therefore, even when the on-vehicle sensor of the newly entering vehicle hardly detects an obstacle that exists on the way to the target position due to the parked vehicle, the newly entering vehicle is allowed to recognize the obstacle (e.g., the parked vehicle) that exists on the way to the target position, from the distributed contour information. Therefore, according to the parking lot control server 10, it is possible to appropriately and safely park the autonomous vehicle.

Various aspects of the present disclosure derived from the embodiment described above will be described below.

A parking lot control server according to an aspect of embodiments of the present disclosure includes: a storage configured to store contour information about a contour of each parked vehicle in a parking lot; an extractor configured to extract contour information corresponding to one or more parked vehicles that are around a travel path of a first vehicle that newly enters the parking lot; and a distributor configured to distribute the extracted contour information to the first vehicle. In the above-described embodiment, the “obstacle information generating apparatus 14” corresponds to an example of the “storage”, the “obstacle information extracting apparatus 15” corresponds to an example of the “extractor”, and the “obstacle information distributing apparatus 16” corresponds to an example of the “distributor”.

The storage may store first contour information about a contour of the first vehicle when the first vehicle completes parking.

The storage may delete second contour information about a contour of a second vehicle when the second vehicle, which is the parked vehicle, leaves the parking lot.

A parking lot control method according to an aspect of embodiments of the present disclosure includes: a first storage step of storing contour information about a contour of each parked vehicle in a parking lot; an extraction step of extracting contour information corresponding to one or more parked vehicles that are around a travel path of a first vehicle that newly enters the parking lot; and a distribution step of distributing the extracted contour information to the first vehicle.

The parking lot control method may further include: a second storage step of storing first contour information about a contour of the first vehicle when the first vehicle completes parking.

The parking lot control method may further include: a deletion step of deleting second contour information about a contour of a second vehicle when the second vehicle, which is the parked vehicle, leaves the parking lot.

A vehicle control apparatus according to an aspect of embodiments of the present disclosure includes: a receiver configured to receive contour information about a contour of a parked vehicle in a parking lot from a parking lot control server; a planner configured to make a traveling plan of a host vehicle on the basis of the contour information; and a controller configured to control the host vehicle such that the host vehicle travels automatically in accordance with the traveling plan. In the above-described embodiment, “the reception unit 21” corresponds to an example of “the receivers”, “the planning unit 22” corresponds to an example of “the planner”, and “the control unit 23” corresponds to an example of “the controller”.

The present disclosure may be embodied in other specific forms without departing from the spirit or characteristics thereof. The present embodiments and examples are therefore to be considered in all respects as illustrative and not restrictive, the scope of the disclosure being indicated by the appended claims rather than by the foregoing description and all changes which come in the meaning and range of equivalency of the claims are therefore intended to be embraced therein.

What is claimed is:

1. A parking lot control server comprising:
a storage configured to store contour information about a contour of each parked vehicle in a parking lot;
an extractor configured to extract contour information corresponding to one or more parked vehicles that are around a travel path of a first vehicle that newly enters the parking lot; and
a distributor configured to distribute the extracted contour information to the first vehicle.

2. The parking lot control server according to claim 1, wherein the storage stores first contour information about a contour of the first vehicle when the first vehicle completes parking.

3. The parking lot control server according to claim 1, wherein the storage deletes second contour information about a contour of a second vehicle when the second vehicle, which is the parked vehicle, leaves the parking lot.

4. The parking lot control server according to claim 2, wherein the storage deletes second contour information about a contour of a second vehicle when the second vehicle, which is the parked vehicle, leaves the parking lot.

5. A parking lot control method comprising:
a first storage step of storing contour information about a contour of each parked vehicle in a parking lot;
an extraction step of extracting contour information corresponding to one or more parked vehicles that are around a travel path of a first vehicle that newly enters the parking lot; and
a distribution step of distributing the extracted contour information to the first vehicle.

6. The parking lot control method according to claim 5, further comprising: a second storage step of storing first contour information about a contour of the first vehicle when the first vehicle completes parking.

7. The parking lot control method according to claim 5, further comprising: a deletion step of deleting second contour information about a contour of a second vehicle when the second vehicle, which is the parked vehicle, leaves the parking lot.

8. The parking lot control method according to claim 6, further comprising: a deletion step of deleting second contour information about a contour of a second vehicle when the second vehicle, which is the parked vehicle, leaves the parking lot.

9. A vehicle control apparatus comprising:
a receiver configured to receive contour information about a contour of a parked vehicle in a parking lot from a parking lot control server;
a planner configured to make a traveling plan of a host vehicle on the basis of the contour information; and
a controller configured to control the host vehicle such that the host vehicle travels automatically in accordance with the traveling plan.
